(19) United States
(12) Patent Application Publication
(10) Pub. No.: US 2026/0311662 A1
(43) Pub. Date: Oct. 8, 2026

(54) Roll-up glockenspiel

(71) Applicant: SONOR GmbH, Bad Berleburg (DE)

(72) Inventors: Britta Fischer, Bad-Berleburg-Wingeshausen (DE); Philipp Rabe, Edertal-Wellen (DE); Maria Wetter, Bad Berleburg-Wingeshausen (DE)

(73) Assignee: SONOR GmbH, Bad Berleburg (DE)

(21) Appl. No.: 19/632,871

(22) Filed: Mar. 30, 2026

(30) Foreign Application Priority Data
Apr. 1, 2025 (DE) 10 2025 001 121.0

(51) Int. Cl. G10D 13/08; G10D 13/24; G10G 7/00

(52) U.S. Cl. CPC G10D 13/08; G10D 13/24; G10G 7/005

(57) ABSTRACT

A bar percussion instrument (1) includes a base surface (2) and a plurality of pegs (3) extending from the base surface (2). Sound plates (4) are arranged parallel to one another and attached to the pegs (3). The base surface (2) consists of a material or a material combination that permits rolling up and unrolling and/or folding and/or collapsing of the base surface (2) at least in a direction perpendicular to the sound plates (4). A system includes the bar percussion instrument and a storage container, preferably a closable container or a box. The storage container is preferably usable as a percussion instrument, cajón, or drum.

### CROSS-REFERENCE TO RELATED APPLICATION

This application claims the benefit of German Patent Application DE 10 2025 001 121.0, filed on Apr. 1, 2025, the contents of which is incorporated in its entirety.

### TECHNICAL FIELD

The disclosure relates to a bar percussion instrument and to a system comprising a bar percussion instrument and a storage container.

### BACKGROUND

Bar percussion instrument have a base surface to which a plurality of pegs are connected, on which in turn sound plates arranged parallel to one another are detachably attached. Bar percussion instruments, also referred to as bar instruments, are multi-tone tuned struck idiophones that include of a plurality of striking bars and belong to the percussion instruments. They are played with up to four mallets. Depending on the material of the sound plates, bar percussion instruments are subdivided, for example, into glockenspiels, xylophones, metallophones, etc. The sound plates are excited into vibration by mallets or strikes and thereby produce the sound characteristic of the respective bar percussion instrument within a tonal spectrum defined by the size and number of the sound plates.

Bar percussion instruments typically comprise pegs or pairs of pegs arranged on a base plate or a resonator body, which in turn carry or integrate a sound plate support and on which the sound plates rest at defined points and are able to vibrate freely. An example of such a bar percussion instrument is disclosed in DE 10 2019 124 890 A1, which focuses on the connection of support pegs and sound bars.

Such bar percussion instruments are used not only by professional musicians, for example in an orchestral context, but are particularly widespread in early childhood music education in preschools and in school music education. In the school environment in particular, and in early childhood music education in general, great importance is attached to the handling of the instruments used, their storage space, their transportability, and their visual appearance. It is also important to limit the weight of the bar percussion instrument to the minimum required for its intended purpose and to ensure a certain durability with respect to improper handling and drops. Bar percussion instruments having known rigid and inflexible base surfaces or resonator bodies address all of these aspects only inadequately.

### SUMMARY

An object of the disclosure is to provide a bar percussion instrument that is capable of overcoming the disadvantages described above and to provide a flexible instrument which, while maintaining operational capability, significantly facilitates its handling, particularly in early childhood music education. This object is achieved by a bar percussion instrument, and by a system comprising a bar percussion instrument and a storage container therefore, as disclosed and claimed.

The bar percussion instrument comprises a base surface to which a plurality of pegs are connected, on which in turn sound plates arranged parallel to one another are detachably attached. The base surface consists of a material or a material combination that permits rolling up and unrolling and/or folding and/or collapsing of the base surface in a direction perpendicular to the sound plates. The a bar percussion instrument can, if necessary, be rolled up and unrolled and/or folded and/or collapsed repeatedly without losing its functional capability. The rolling up and unrolling and/or folding and/or collapsing in a direction perpendicular to the sound plates makes it possible that, in such a compressed bar percussion instrument or one having a reduced support surface, the sound plates essentially do not participate in the rolling process but rather can be arranged parallel to one another and mechanically unloaded. In order to achieve the capability of rolling up and unrolling and/or folding and/or collapsing of the bar percussion instrument, the material and the arrangement of the sound plates on the base surface can remain unchanged, and only the material or the material combination for the base surface must be adapted to the new requirement of rollability and unrollability and/or foldability and/or the ability to be collapsed.

The bar percussion instrument is easy to handle and can be easily stored with a low space requirement without exhibiting impairments with respect to its functionality or form after restoring a use configuration by unrolling, unfolding and/or releasing the collapsed state. The bar percussion instrument is versatile and does not require a flat support surface; rather, it can also be used resting on uneven surfaces or close to the body, for example resting on the knees, the lap, or the back of a person, or can be played while suspended. It is therefore particularly suitable for use in elementary music education, for children and elderly persons, as well as for use in sound therapy. Compared with conventional bar percussion instruments, the bar percussion instrument provides increased playability and a new tactile sensation while maintaining the same timbre and tonal range.

It is preferred that the base surface comprises a plurality of layers connected to one another, preferably several layers of identical size and shape, which in a particularly preferred embodiment are connected to one another in a form-fitting, materially bonded and/or force-fitting manner, preferably stitched and/or adhesively bonded and/or connected by means of clips or snap fasteners or by a zipper. This provides a bar percussion instrument which, with preferably unchanged rollability and unrollability, foldability and/or collapsibility, allows the base surface, after unrolling or unfolding, to rest on a substantially flat substrate or an uneven substrate, while at the same time ensuring that a smooth surface of the base surface can be provided at least with respect to the support surface, preferably both with respect to the support surface and on the surface of the base surface facing the sound plates. This is particularly relevant when pegs, individually or in pairs per sound plate, penetrate through at least one layer of the base surface and are fixed in place between at least two connected layers of the base surface.

It is further preferred that the rolling up and unrolling and/or folding and/or collapsing of the base surface is executable while maintaining the existing connection with the sound plates and/or the pegs. This creates a bar percussion instrument which can be rolled up and unrolled particularly easily and quickly, and is thus usable without delay for transport, storage, or use.

In this context, it is further preferred that the base surface is manufactured from a material or a material combination that is not plastically deformable during intended use of the bar percussion instrument. It is further preferred that the base surface comprises at least one felt layer, preferably consists of one or more felt layers. In an alternative embodiment, which is likewise preferred, the base surface comprises at least one neoprene layer, preferably consisting of one or more neoprene layers. In a further alternative embodiment, which is likewise preferred, the base surface comprises at least one fabric layer, preferably consisting of one or more fabric layers. A material combination may include at least two layers of different materials, for example a felt layer combined with a neoprene layer. In all cases, a base surface is provided that can be readily rolled up and unrolled, can be colored or printed in virtually any manner, and makes rolling up and unrolling particularly easy to implement even by children. It is particularly preferred that the base surface itself or its outer layers are configured to be cleanable or washable with commercially available cleaning agents.

It is also preferred that the pegs are connected to the base surface in pairs, such that each sound plate is assigned a pair of pegs. This ensures that the spacing of the pegs assigned to each sound plate is reliably matched to corresponding holes, in particular punched holes or drilled holes, within the sound plates in an unchangeable manner. Due to the rollability and unrollability, foldability and/or collapsibility of the bar percussion instrument in a direction perpendicular to the sound plates, no negative influence on the configuration of the pegs connected in pairs is to be expected, as long as no material connection is present between the pegs of adjacent sound plates.

It is furthermore preferred that the pegs are guided through holes, preferably punched or drilled holes or slot-shaped openings, through at least one layer of the base surface. This ensures that the pegs remain securely in place and do not shift relative to one another even during repeated rolling up and unrolling, folding and unfolding, and/or collapsing and separating of the base surface. Likewise, the sound plates also remain arranged parallel to one another even during repeated rolling up and unrolling and/or folding and unfolding of the bar percussion instrument.

In general, the sound bars may be connected to the bar percussion instrument in a conventional manner by pegs, nails, or rivets. However, it is preferred that the sound bars rest on pegs and that the pegs preferably comprise a protrusion that prevents the pegs from being pulled out through the base surface in that the peg protrusions are dimensioned wider than the openings formed in the base surface for the pegs. It may also be preferred that in each case two pegs are connected by a common protrusion, which is arranged below at least the uppermost material layer and connects two pegs to one another and is preferably arranged parallel to the orientation of the sound bars. Since only the pegs project through the openings within the base surface, undesired pulling out can be reliably prevented.

In general, it is preferred that the pegs are connected to one another at their ends facing away from the sound bars via one or more preferably flexible material strips, which are preferably stitched and/or adhesively bonded to the base surface in particular. These flexible material strips likewise ensure a permanently consistent alignment of the pegs and of the sound plates connected thereto. It is also preferred that the sound plates are connected to the pegs such that they are mounted in a freely vibrating manner at the ends of the pegs facing away from the base surface, preferably resting on flexible bands, particularly preferably felt bands or rubber bands, which are connected to the pegs. This provides a bar percussion instrument which, on the one hand, supports—by simple and controllable means—the flexible and movable configuration of the base surface and of the bar percussion instrument as a whole in terms of material, enabling it to be rollable, foldable, and collapsible, and, on the other hand, ensures free vibration of the sound plates so that the sound of the bar percussion instrument remains unchanged compared to conventional bar percussion instruments.

In this context, it is also preferred that the sound plates comprise holes, in particular punched holes or drilled holes, through which the pegs extend, the pegs being configured to support the sound plates. This ensures that the sound plates can be securely and permanently connected to the pegs and that the vibration of the sound plates is permanently ensured without change.

It is preferred that the support points of the sound plates on the pegs are configured such that vibrational decoupling of the sound plates and the base surface is present. Vibrational decoupling is understood to mean that this is achieved to the greatest extent possible, as is typically achievable in bar percussion instruments of the type in question.

It is furthermore preferred that the bar percussion instrument is a glockenspiel or a xylophone or a metallophone, or an instrument whose sound plates comprise a fiberglass material. As already described above, the bar percussion instrument is not limited to the material of the sound plates themselves; rather, different types of sound plates of any kind can be connected to a rollable and unrollable and/or foldable and/or collapsible base surface. In any case, it is ensured that the bar percussion instrument is, in terms of material, rollable and/or foldable and/or collapsible, flexible, and movable, and can thereby also be played on uneven support surfaces, optionally in a bent or twisted state or in a suspended condition and thus in a vertically arranged orientation.

According to a further aspect, a system is provided comprising a bar percussion instrument according to the first aspect and a storage container for the bar percussion instrument, characterized in that the storage container is designed and configured to receive the bar percussion instrument in a rolled-up and/or folded and/or collapsed state. This provides a system that enables secure storage and transportation of the bar percussion instrument and reliably prevents contamination even during prolonged storage.

It is preferred that the storage container has a cylindrical shape. The cylindrical shape of the storage container additionally enables space-saving storage of the bar percussion instrument, in particular in a rolled-up and thus likewise substantially cylindrical state.

In a preferred embodiment, the storage container comprises a preferably removable lid. Finally, in a particularly preferred embodiment, the storage container is a can or a box which, at least in an empty state, is usable as a percussion instrument, cajón, or drum. This provides a system which, by particularly simple means, provides two instruments that can be stored and transported together and optionally also played together.

### BRIEF DESCRIPTION OF THE DRAWINGS

FIG. 1 shows an exploded and assembled view of a base surface of a bar percussion instrument with integrated pegs.

FIG. 2 shows an exploded view of a system comprising a bar percussion instrument and a storage container.

### DETAILED DESCRIPTION

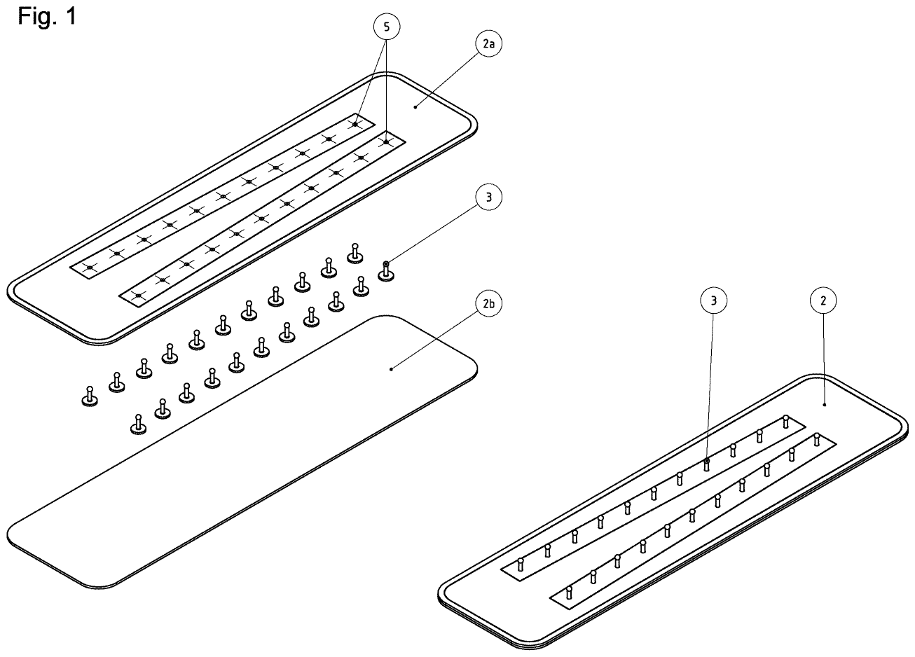

FIG. 1 shows an exploded view of a base surface 2 as used in a bar percussion instrument, as well as a representation of an assembled base surface 2 with pegs 3 integrated therein. In the illustrated embodiment, the base surface 2 consists of a bottom layer 2b and a top layer 2a. While the bottom layer 2b is continuous and formed as a continuous surface, the top layer 2a comprises a plurality of holes 5 for partial passage of the pegs 3. The holes 5 are formed in pairs for each sound plate within the top layer 2a and are dimensioned such that the projections of the pegs 3 can pass through the holes 5, while the respective peg protrusions remain supported below the top layer 2a and on the bottom layer 2b, in order, on the one hand, to ensure the alignment of the pegs 3 perpendicular to the base surface 2 and, on the other hand, to serve as pull-out protection for the pegs 3. The two layers 2a, 2b are shown in FIG. 1 as being adhesively bonded and stitched together and illustrate a permanent connection of the base surface 2 with the pegs 3, which are configured in the manner shown for receiving sound plates.

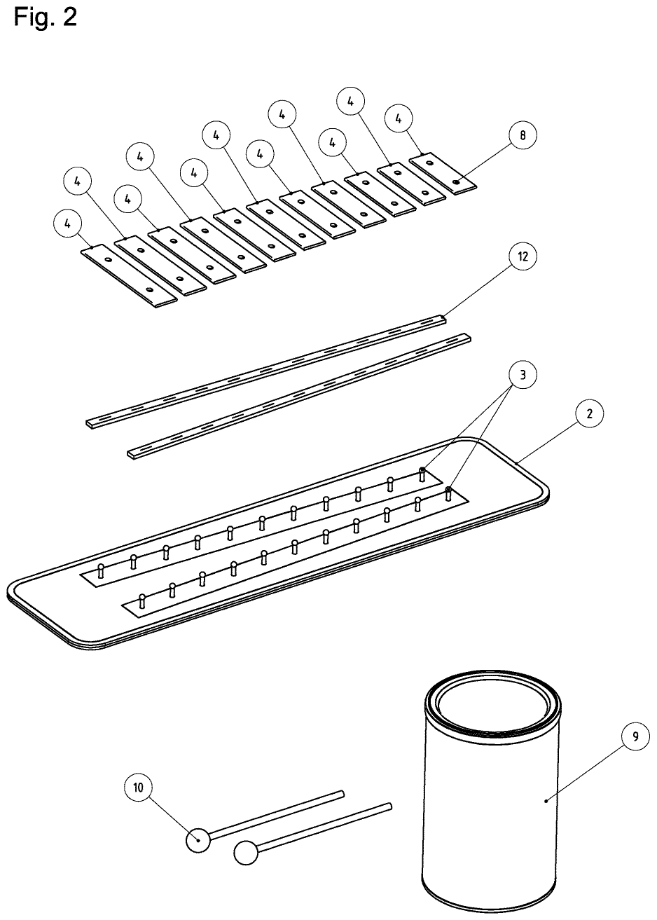

FIG. 2 shows an exploded view of a system, consisting of a bar percussion instrument 1 and a storage container 9. The system comprises a base surface 2 with pegs 3 attached thereto, as already shown in FIG. 1, as well as two felt strips 12, which are placed on a respective row of pegs 3 such that the tips of the pegs 3 pass through the felt strips 12, in particular through holes arranged in these felt strips 12, and can engage in the holes 8 within each sound plate 4. This effects vibrational decoupling of the base surface 2 from the sound plates 4. The material of the base surface 2 as well as of the strips 12 is configured such that rolling up and/or folding and/or collapsing of the bar percussion instrument 1 can take place perpendicular to the orientation of the sound plates 4 or parallel to the longitudinal orientation of the base surface 2 and the felt strips 12 in such a way that the rolled-up or folded or collapsed bar percussion instrument 1 can ultimately be inserted into the storage container 9, optionally together with the mallets 10. It is particularly preferred that the storage container 9 itself is usable as a percussion instrument.

What is claimed is:

1. A bar percussion instrument (1), comprising:
a base surface (2);
a plurality of pegs (3) connected to the base surface (2); and
sound plates (4) arranged parallel to one another and attached to the plurality of pegs (3),
wherein the base surface (2) consists of a material or a material combination that permits rolling up and unrolling, and/or folding, and/or collapsing of the base surface (2) in a direction perpendicular to the sound plates (4).

2. The bar percussion instrument (1) according to claim 1,
wherein the base surface (2) comprises a plurality of layers of identical size and shape connected to one another.

3. The bar percussion instrument (1) according to claim 2,
wherein the plurality of layers of the base surface (2) are stitched and/or adhesively bonded to one another.

4. The bar percussion instrument (1) according to claim 1,
wherein the rolling up and unrolling, and/or folding, and/or collapsing of the base surface (2) is performable while the sound plates (4) and the pegs (3) remain connected to the base surface (2).

5. The bar percussion instrument (1) according to claim 1,
wherein the material or the material combination is not plastically deformable by the rolling up and unrolling and/or folding and/or collapsing.

6. The bar percussion instrument (1) according to claim 1,
wherein the base surface (2) consists of one or more felt layers.

7. The bar percussion instrument (1) according to claim 1,
wherein the base surface (2) consists of one or more neoprene layers.

8. The bar percussion instrument (1) according to claim 1,
wherein the base surface (2) consists of one or more fabric layers.

9. The bar percussion instrument (1) according to claim 1,
wherein the pegs (3) are connected to the base surface (2) in pairs, such that each of the sound plates (4) is assigned a respective pair of the pegs (3).

10. The bar percussion instrument (1) according to claim 1,
wherein the pegs (3) are guided through holes (5) through at least one layer of the base surface (2).

11. The bar percussion instrument (1) according to claim 1,
wherein the pegs (3) are connected to one another at ends facing away from the sound plates (4), via one or more flexible material strips, and
wherein the one or more flexible material strips are stitched and/or adhesively bonded to at least one layer of the base surface (2).

12. The bar percussion instrument (1) according to claim 1,
wherein the sound plates (4) are connected to the pegs (3) in a freely vibrating manner at ends of the pegs (3) facing away from the base surface (2), resting on flexible bands connected to the pegs (3).

13. The bar percussion instrument (1) according to claim 12,
wherein the flexible bands are configured to connect one peg (3) of each of the sound plates (4).

14. The bar percussion instrument (1) according to claim 1,
wherein the sound plates (4) comprise elongated holes (8) through which the pegs (3) extend, thereby supporting the sound plates (4).

15. The bar percussion instrument (1) according to claim 1,
wherein support points of the sound plates (4) on the pegs (3) are configured to provide vibrational decoupling of the sound plates (4) from the base surface (2).

16. The bar percussion instrument (1) according to claim 1,
wherein the bar percussion instrument (1) is a glockenspiel or a xylophone or a metallophone.

17. The bar percussion instrument (1) according to claim 1,
wherein the sound plates comprise fiberglass material.

18. A system, comprising:
the bar percussion instrument (1) according to claim 1; and
a storage container for the bar percussion instrument (1),
wherein the storage container is designed and configured to receive the bar percussion instrument (1) in a rolled-up or folded or collapsed state.

19. The system according to claim 18,
wherein the storage container comprises a removable lid or closure.

20. The system according to claim 18,
wherein the storage container is usable, at least in an empty state, as a percussion instrument, cajón, or drum.
